(19) United States
(12) Patent Application Publication
(10) Pub. No.: US 2012/0076977 A1
(43) Pub. Date: Mar. 29, 2012

(54) REINFORCED WOOD PRODUCT AND REINFORCEMENT COMPONENT

(75) Inventor: Thomas F. Schulner, Tacoma, WA (US)

(73) Assignee: WEYERHAEUSER NR COMPANY, Federal Way, WA (US)

(21) Appl. No.: 12/891,645

(22) Filed: Sep. 27, 2010

(51) Int. Cl. B32B 3/10

(52) U.S. Cl. 428/119; 428/209

(57) ABSTRACT

The present disclosure relates to reinforced wood products and reinforcement components for use with wood products. In some embodiments, reinforced wood products according to the disclosure include a wood component and a reinforcement component. The reinforcement component may include one or more metal plates and one or more fixation mechanisms. The metal plates may be attached to at least one reinforced surface of the wood component so that the reinforcement component extends over less than about 35% of the length of the wood component. In some embodiments, reinforcement components according to the disclosure may also include one or more buckling resistance notches.

### TECHNICAL FIELD

The present disclosure is directed generally to reinforced wood products and reinforcement components for use with wood products in structural framing applications.

### BACKGROUND

Every year a considerable volume of wood products (e.g., lumber, engineered wood products, etc.) are used in residential, commercial, and industrial construction applications. Wood products are often utilized as the primary components in framing systems (e.g., studs, joists, rafters, etc.). One problem regularly encountered in structural framing applications involves the relationship between water and wood's physical properties and dimensional stability. When the moisture content in a wood product increases or decreases, the wood may shrink or swell as a result. Shrinking and swelling after installation can result in a number of problems. As the dimensions of the wood changes, it may twist or bow, causing bumps and nail pops in walls; squeaky and wavy floors; or other aesthetic and structural defects. When numerous wood products are connected to build a frame and the various frame components experience dissimilar shrinkage or swelling, the frequency and noticeability of such defects can be exacerbated.

Wood product manufacturing companies and builders have experimented with various solutions to the problems caused by differential shrinkage in the wood products used for structural framing. Many lumber manufacturers dry lumber in kilns or treat it using processes designed to condition the wood before installation. Builders may discard certain pieces of wood due to natural imperfections or wait to nail down the frame, thereby allowing it to settle. Joist hangers and other mechanical reinforcement mechanisms may also be utilized to enhance the dimensional stability of wood products in structural frames. Each of these solutions have drawbacks including the requirement of additional, time, money, and equipment.

U.S. Pat. No. 4,586,550 (hereafter the '550 patent) proposes the solution of reinforcing a structural wood member with metal. The disclosure of the '550 patent describes a method for reinforcing a timber beam by mounting sheet metal strips or plates on the top and/or bottom surfaces of the beam. A person of ordinary skill in the art will appreciate that a structural wood member is generally longer than it is thick. Accordingly, the two top and bottom surfaces are typically narrow and are used to secure a floor, ceiling, roof, wall covering, etc. Thus, attaching metal strips or plates to the top and/or bottom surfaces of a conventional floor joist in accordance with the '550 patent may interfere with fixation of the floor to the other structural components.

U.S. Pat. No. 6,167,675 (hereafter the '675 patent) recognizes this shortcoming of the '550 patent and offers a solution. According to the disclosure of the '675 patent, a structural wood member may be reinforced by applying a longitudinal metal reinforcement to at least one lateral surface of the wood member. The metal reinforcement is secured to the wood member at predetermined intervals over substantially the entire length of the wood member using metal teeth. Although this practice may be effective to increase the rigidity of the wood member and addresses the shortcomings of the '675 patent, it may be very costly and impractical to reinforce the entire length of the wood member. In addition, doing so may not be effective to reduce problems associated with horizontal shearing of wood products in structural frames.

Accordingly, there is a need to develop new systems and methods to address the problems associated with swelling and shrinkage in structural framing components made from wood products. More specifically, there is a need to develop new reinforced wood products, methods for reinforcing wood products, and reinforcement components for use with wood products.

### SUMMARY

The following summary is provided for the benefit of the reader only and is not intended to limit in any way the invention as set forth by the claims. The present disclosure is directed generally towards reinforced wood products and reinforcement components for use with wood products in structural framing applications.

In some embodiments, reinforced wood products according to the disclosure include a wood component and a reinforcement component. The reinforcement component may include one or more metal plates and one or more fixation mechanisms. The metal plates may be attached to at least one reinforced surface of the wood component so that the reinforcement component extends over less than about 35% of the length of the wood component. In some embodiments, reinforcement components according to the disclosure may also include one or more buckling resistance notches. Further aspects are directed towards specific types of reinforcement components for use with wood products.

### BRIEF DESCRIPTION OF THE DRAWINGS

The present disclosure is better understood by reading the following description of non-limitative embodiments with reference to the attached drawings wherein like parts of each of the figures are identified by the same reference characters, and are briefly described as follows:

FIG. 1 is top view of a first embodiment of a reinforced wood product according to the disclosure;

FIG. 2 is top view of a second embodiment of a reinforced wood product according to the disclosure;

FIG. 3 is a side view of a portion of the reinforced wood product from FIG. 2;

FIG. 4 is top view of a third embodiment of a reinforced wood product according to the disclosure;

FIG. 5 is top view of a fourth embodiment of a reinforced wood product according to the disclosure;

FIG. 6 is a side view of a buckling resistance notch according to embodiments of the disclosure;

FIG. 7 is a side view of a portion of the reinforced wood product from FIG. 5;

FIG. 8 is top view of an embodiment of a reinforced wood product according to the disclosure tested as part of the Examples;

FIG. 9 is top view of another embodiment of a reinforced wood product according to the disclosure tested as part of the Examples;

FIG. 10 is a side view of a portion of the reinforced wood product from FIG. 9;

FIG. 11 is a plot of width versus elapsed time for Example 1;

FIG. 12 is a plot of percentage of width change from initial width and moisture content versus elapsed time for Example 1;

FIG. 13 is a table summarizing data from Example 1

FIG. 14 is a plot of width versus elapsed time for Example 2; and

FIG. 15 is a plot of percentage of width change from initial width versus elapsed time for Example 2.

### DETAILED DESCRIPTION

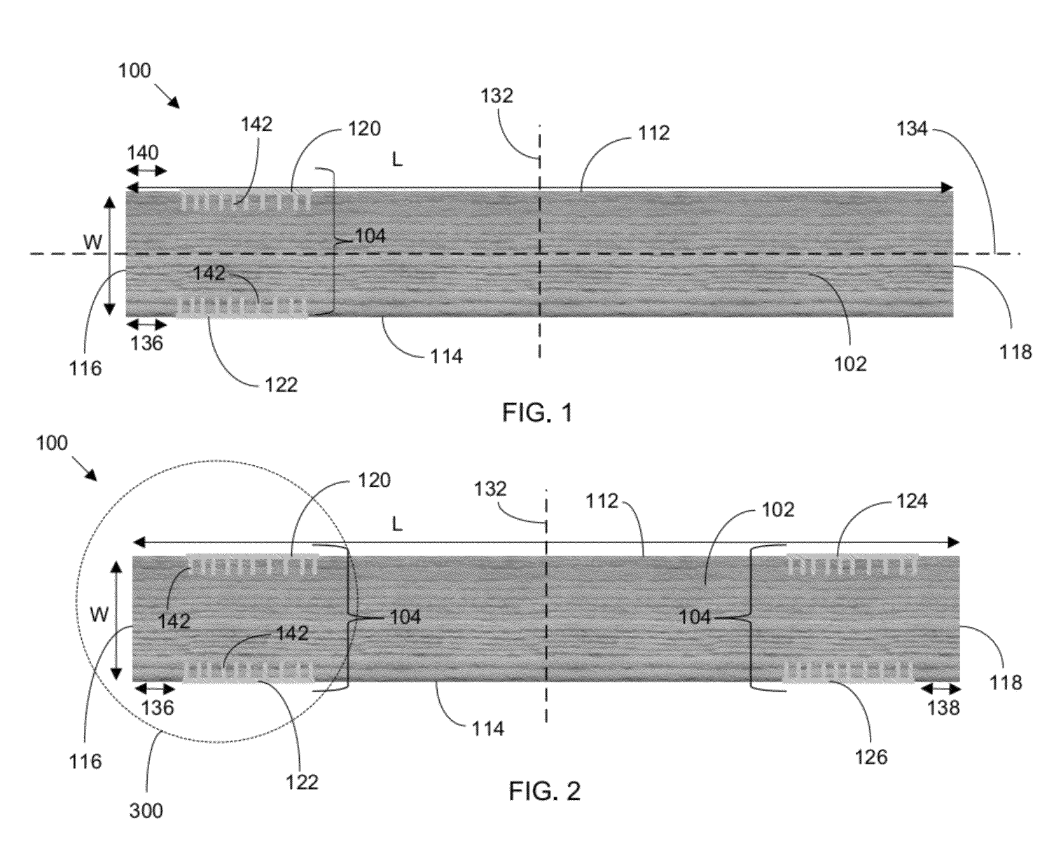

The present disclosure describes reinforced wood products and reinforcement components for use with wood products. Certain specific details are set forth in the following description and FIGS. 1-15 to provide a thorough understanding of various embodiments of the disclosure. Well-known structures, systems, and methods often associated with such systems have not been shown or described in details to avoid unnecessarily obscuring the description of various embodiments of the disclosure. In addition, those of ordinary skill in the relevant art will understand that additional embodiments of the disclosure may be practiced without several of the details described below.

In this disclosure, the term “wood” is used to refer to any organic material produced from trees, shrubs, bushes, grasses or the like. The disclosure is not intended to be limited to a particular species or type of wood. The term “wood product” is used to refer to a product manufactured from logs such as lumber (e.g., boards, dimension lumber, solid sawn lumber, joists, headers, beams, timbers, laminated, finger jointed, or semi-finished lumber); veneer products; or wood strand products (e.g., oriented strand board, oriented strand lumber, laminated strand lumber, parallel strand lumber, and other similar composites); or components of any of the aforementioned examples. The term “floor joist” is used to refer to horizontal wood products laid on edge resting on the beams or walls that provide the main support for a floor.

FIGS. 1-7 depict various embodiments of reinforced wood products 100 according to the disclosure. Generally, reinforced wood products 100 according to the disclosure include a wood component 102 and a reinforcement component 104. Wood components 102 according to the disclosure may be any type of wood product mentioned above or any wood product that may be equivalent to those mentioned above from the perspective of person of ordinary skill in the art. In the embodiments illustrated in the disclosure, the wood component 102 is generally shown as a floor joist for installation in a flooring system; however, the scope of the disclosure should not be limited to wood products of this type or intended for this use. In other embodiments, reinforcement components 104 according to the disclosure may be used with various different types of wood products suitable for various applications.

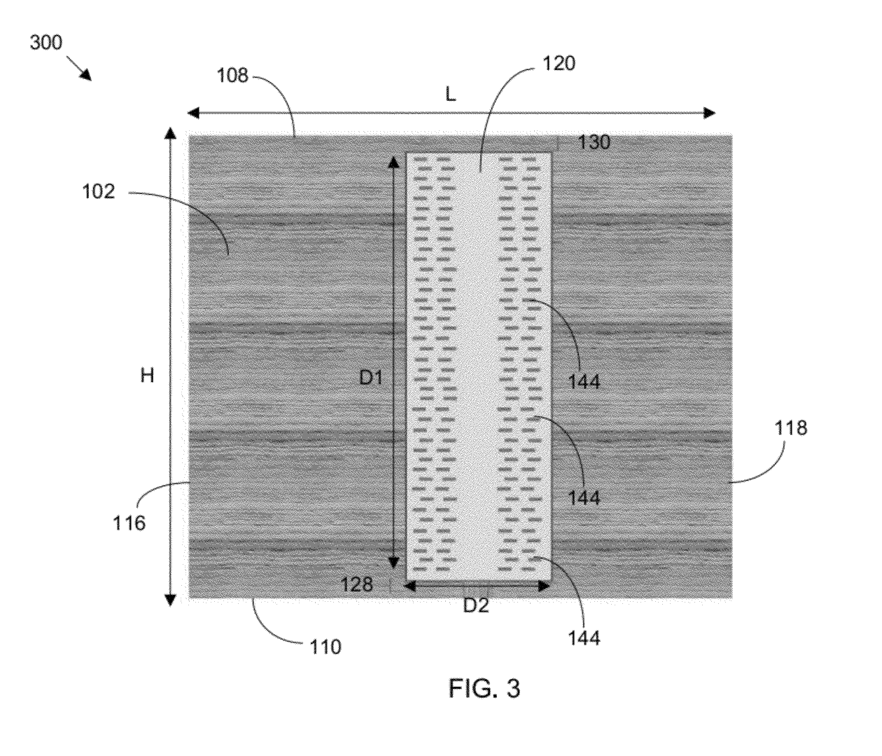

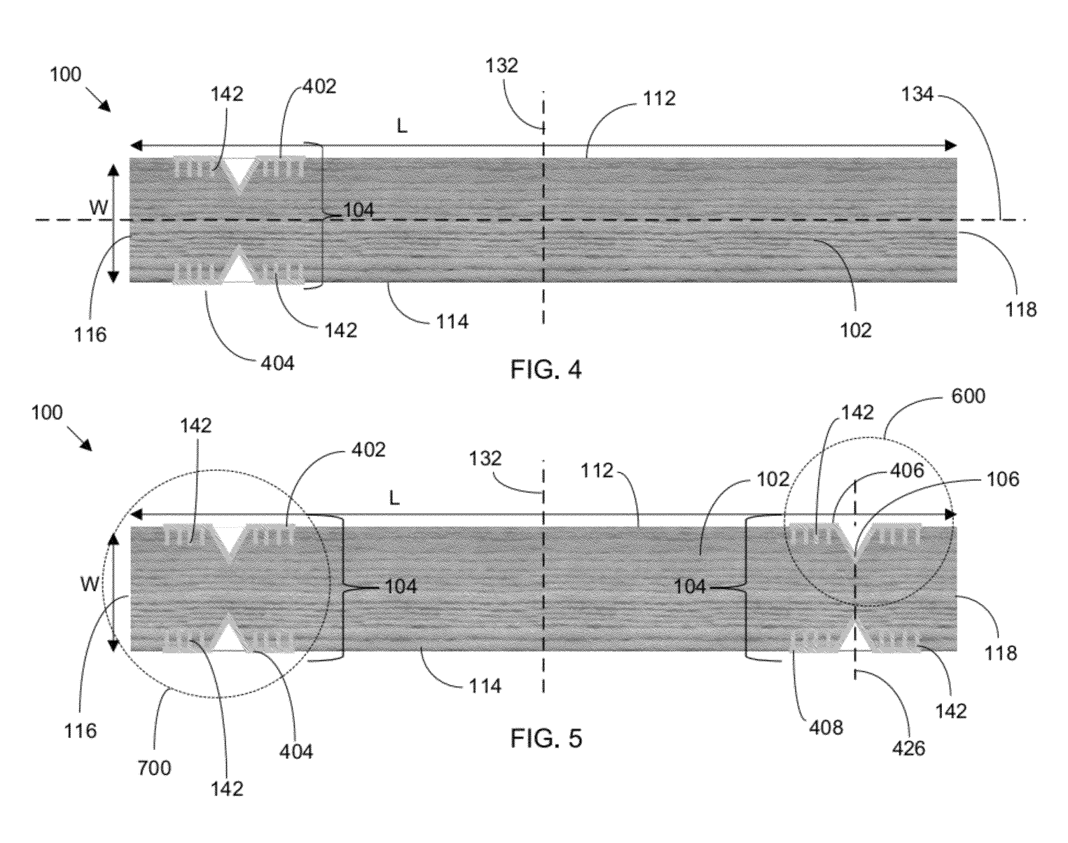

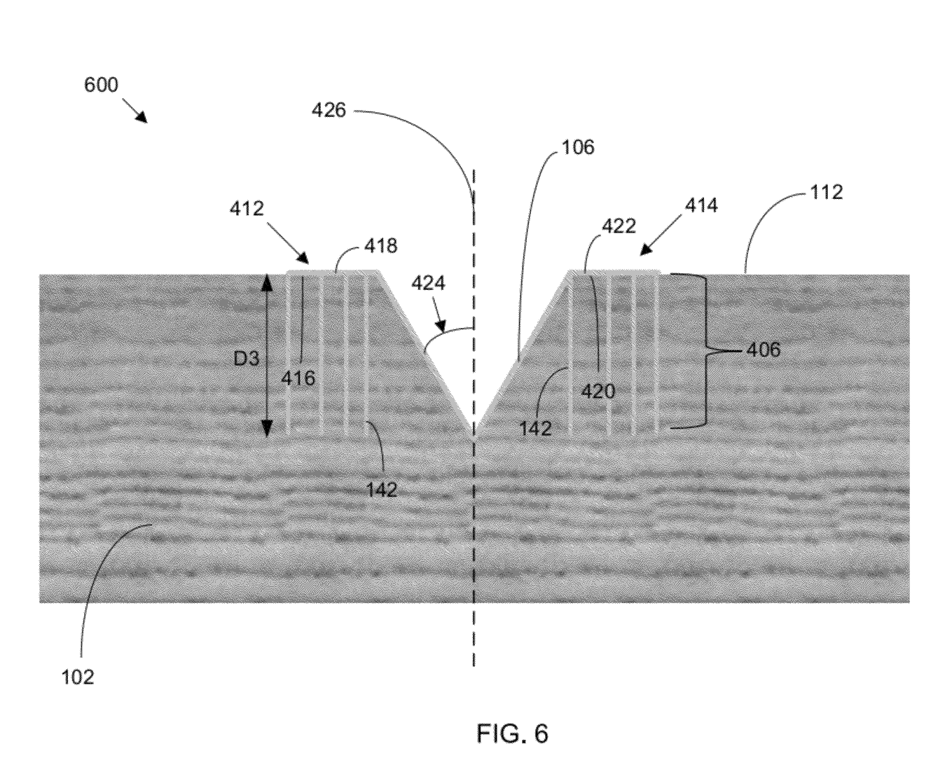

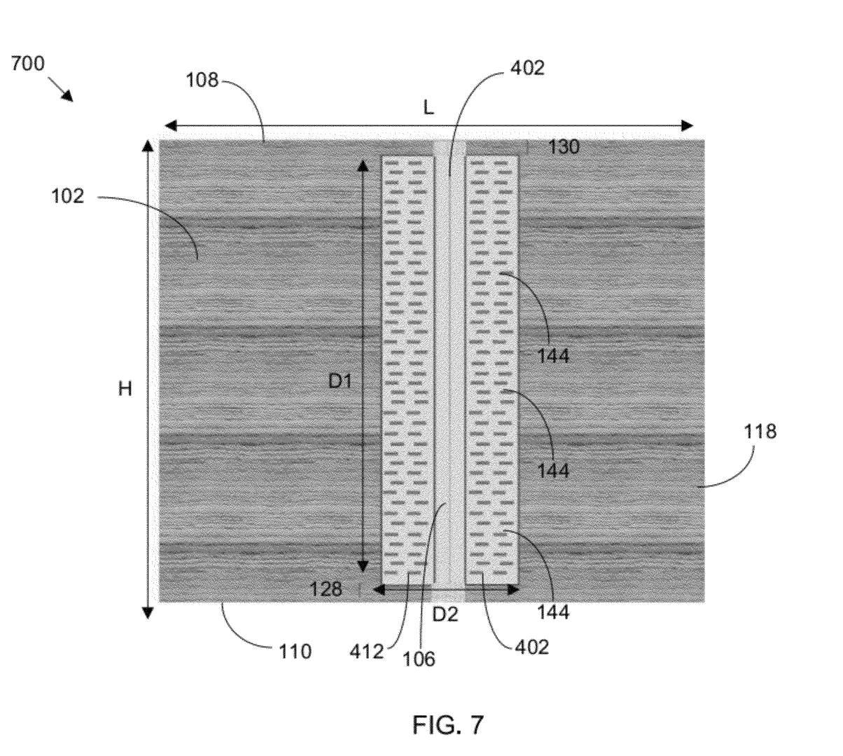

Reinforcement components 104 according to the disclosure may have a number of different forms and configurations. In some embodiments, reinforcement components 104 according to the disclosure feature a buckling resistance notch 106. FIGS. 1-3 depict embodiments of reinforced wood components 104 without the buckling resistance notch 106. FIGS. 4-7 depict embodiments of reinforcement components 104 with the buckling resistance notch 106. FIG. 1 depicts a first embodiment of the reinforcement component 104 and FIG. 2 depicts a second embodiment of the reinforcement component 104. FIG. 3 depicts a portion of the reinforcement wood product 100 from FIG. 2. FIG. 4 depicts a third embodiment of the reinforcement component 104 and FIG. 5 depicts a fourth embodiment of the reinforcement component 104. FIG. 6 depicts details of a buckling resistance notch 106 according to embodiments of the disclosure. FIG. 7 depicts a portion of the reinforcement wood product 100 from FIG. 5.

Referring to FIGS. 1-7, wood components 102 according to the disclosure each have a length L, a width W, and a height H as shown. Additionally, wood components 102 according to the disclosure have a top surface 108, a bottom surface 110, a first lateral surface 112, a second lateral surface 114, and two ends (a first end 116 and a second end 118). In a floor joist application, the wood component 102 may be a solid sawn piece of lumber having conventional dimensions. Accordingly, the wood component 102 may be a 2×8 joist, a 2×10 joist, or a 2×12 joist. A 2×8 joist traditionally has a length L of about 8 feet, a width W of about 1.5 feet, and a height of about 2 feet. A 2×10 joist traditionally has a length L of about 12 to about 16 feet, a width W of about 1.5 inches, and a height of about 9.25 inches. A 2×12 joist traditionally has a length L of about 12 to about 20 feet, a width W of about 1.5 Inches, and a height of about 11.25 inches feet. In a floor joist application, the top surface 108 and the bottom surface 110 of the wood component 102 may be used to secure the joists to the other structural framing components. Methods for installing wood products in flooring systems are described, for example, in U.S. Pat. No. 6,145,261, U.S. Pat. No. 6,301,854, and U.S. Pat. No. 7,603,912, all of which are hereby incorporated by reference. In applications using different types of wood products, installation methods would be apparent to a person of ordinary skill in the art and are therefore not described in detail.

Embodiments of reinforced wood products 100 utilizing reinforcement components 104 without the buckling resistance notch 106 (FIGS. 1-3) will now be described in detail. Referring specifically to FIG. 1, reinforcement components 104 according to the disclosure may include one or more metal plates attached to at least one reinforced surface of the wood component 102. In the embodiment shown in FIG. 1, the reinforced component 104 includes a first metal plate 120 and a second metal plate 122. Although the plates in this disclosure are described as metal, a person of ordinary skill in the art will appreciate that other materials with suitable properties may also be used. Suitable metals for use with embodiments of the disclosure include steel aluminum, and other metals and alloys known to a person of ordinary skill in the art.

In FIG. 1, the reinforced surface for the first metal plate 120 may be the first lateral surface 112. The reinforced surface for the second metal plate 122 may be the second lateral surface 114. In other embodiments, different configurations and numbers of metal plates may be used. For example, the first metal plate 120 could be affixed to the wood component 102 without the second metal plate 122. In addition, the reinforced surface(s) may be different surface(s) than those explicitly shown.

FIG. 2 is a top view of a reinforced wood product 100 including the wood component 102 and a different embodiment of the reinforcement component 104. In FIG. 2, the reinforcement component 104 includes the first metal plate 120 and the second metal plate 122 from FIG. 1. The reinforcement component 104 also includes a third metal plate 124 and a fourth metal plate 126. The reinforced surface for the first metal plate 120 and the third metal plate 124 may be the first lateral surface 112. The reinforced surface for the second metal plate 122 and the fourth metal plate 126 may be the second lateral surface 114. In other embodiments, different configurations and numbers of metal plates may be used. Further, the reinforced surfaces may be different than those explicitly shown.

FIG. 3 is a side view of a portion 300 of the reinforcement wood product 100 from FIG. 2. In FIG. 3, a more detailed view of the reinforced surface and reinforcement component 104 is shown. In the embodiment in FIG. 3, the reinforced surface is the first lateral surface 112, which is parallel to the surface of the page. The first metal plate 120 is shown extending over about 75% of the height H of the wood component 102. In some embodiments, the first metal plate 120 (and other metal plates that are part of the reinforcement component 104) may extend over about 75% of the height H of the wood component 102 to about 100% of the height H of the wood component 102. Accordingly, the dimensions of the first metal plate 120 (and other metal plates) may vary according to the dimensions of the wood component 102. In some embodiments, the first metal plate 120 may have a first dimension D1 and a second dimension D2, with D1 being substantially greater than D2. For a floor joist application, D1 may measure anywhere from about 9 inches to about 24 inches. D2 may measure anywhere from about 2 inches to about 5 inches. Metal plates according to the disclosure may have a thickness (not shown) ranging from about 0.035 inches to about 0.06 inches. For other applications, measurements for the thickness and D1 and D2 may have other values that would be suitable to a person of ordinary skill in the art.

In the embodiment shown in FIG. 3, portions of the wood component 102 are not covered. A first non-reinforced portion 128 and a second non-reinforced portion 130 may be used to attach the wood component 102 to the other structural framing components. In a floor joist application, for example, the non-reinforced portions may be used to hang the floor joist in place. Accordingly, the non-reinforced portions may have dimensions ranging anywhere from about 0.25 inches to about 0.5 inches. The dimensions of the first non-reinforced portion 128 and the second non-reinforced portion 130 may be the same or different. In embodiments involving wood products other than those shown in FIG. 3, the non-reinforced portions may have different dimensions and may be used in any manner that would be known to a person of ordinary skill in the art.

Referring to FIGS. 1-3, reinforcement components 104 according to the disclosure may be arranged in various positions along the length L of the wood component 102. A horizontal axis 132 and a primary vertical axis 134 are used as reference points to illustrate these positions. The horizontal axis 132 divides the wood component approximately in half. Accordingly, reinforcement components 104 according to the disclosure may be attached near the first end 116 of the wood component 102 or near the second end 118 of the wood component 118. In some embodiments, reinforcements components 104 may be attached a first distance 136 away from the first end 116 and/or a second distance 138 away from the second end 118. The first distance 136 and the second distance 138 may be the same or different. In some embodiments, the first distance 136 and the second distance 138 may be anywhere between about 1 inch to about 6 inches.

In some embodiments, opposing metal plates in reinforcement components 104 may be attached at different distances away from the same end. For example, in FIG. 1, the first metal plate 120 may be attached to the wood component 102 at a third distance 140 from the first end 116. The second metal plate 122 may be attached to the wood component 102 at the first distance 136. Although FIG. 1 shows the first distance 136 and the third distance 140 to schematically the same, in some embodiments, they may be different.

In a floor joist application, attaching one or more reinforcement components 104 near the ends of the joists is expected to reduce the negative effects associated with shrinkage and swelling in wood products used in structural framing applications. Such problems are often encountered during environmental and seasonal changes. Reinforcement components 104 according to the disclosure may act as a brace for each wood product 100, thereby restraining and minimizing shrinkage from component to component in the structural frame.

Different numbers and arrangements of metal plates may be used in reinforcement components 104 according to the disclosure. Whereas FIG. 1 shows an embodiment having only two metal plates (the first metal plate 120 and the second metal plate 122), FIG. 2 shows an embodiment having four metal plates (the first metal plate 120 and the second metal plate 122, the third metal plate 124, and the fourth metal plate 126). In some embodiments, one or more metal plates may be arranged so that the reinforcement component 104 is substantially symmetric about the primary vertical axis 134. In other embodiments, reinforcement components 104 according to the disclosure do not exhibit such symmetry. For example, a single metal plate may be attached to a single reinforced surface on the wood component 102. Alternatively, the embodiment in FIG. 1 may be modified so that the first metal plate 120 and the second metal plate 122 are not symmetric about the primary vertical axis 134. For example, the first metal plate 120 may have different dimensions than the second metal plate 122. The metal plates may also be arranged in positions along the length L of the wood component so they are symmetric about the primary vertical axis 134.

Referring to back to FIGS. 1-3, embodiments of reinforcement components 104 according to the disclosure are attached to the wood component to extend over less than about 35% of the length L of the wood component 102. This percentage may be based on the number and size of the plates used. In some embodiments, reinforced wood products 100 according to the disclosure include one or more reinforcement components 104, which cover between about 15% and about 20% of the total surface area of the wood component 102.

Referring again to FIGS. 1 and 2, one or more fixation mechanisms may be used to attach the metal plates to the wood component 102. In some embodiments, fixation mechanisms according to the disclosure may include teeth, glue, screws, nails, or any other suitable means for attaching wood to metal that is known to a person of ordinary skill in the art. In the embodiments shown in FIGS. 1 and 2, the fixation mechanisms include one or more teeth 142 extending from the metal plates. The teeth 142 are configured to extend into the wood component 102 in an orientation that is substantially perpendicular to the reinforced surface. The teeth 142 may extend a distance about 0.25 inches to about 0.5 inches into the wood component 102.

In some embodiments, reinforcement components 104 according to the disclosure may be manufactured using conventional techniques such as those used in truss plate manufacturing. Reinforcement components 104 according to the disclosure generally include a substantially rectangular section having edges that form right angles. Sheets of material having suitable dimensions may be cut into rectangular sections and teeth 142 may be stamped into the rectangular sections using conventional stamping operations. FIG. 3 shows examples of holes 144 formed by stamping teeth 142 into a rectangular sheet of metal in order to construct a reinforcement component 104 according to embodiments of the disclosure. A person of ordinary skill in the art will appreciate that the present disclosure is not limited to the particular pattern of stamping shown in FIG. 3. Accordingly, reinforcement components 104 according to the disclosure may have any number of teeth 142 arranged in any suitable configuration.

In some applications, installation of a flat metal plate such as those described above with respect to FIGS. 1-3 is expected to mitigate shrinkage in reinforced wood products 100 when compared with wood products not fitted with reinforcement components 104 according to the disclosure. In some applications, reinforced wood products 100 may experience buckling due to the minimal thickness of the reinforcement component 104. One possible solution may include profiling the plate to add a buckling resistance notch 106 as shown in FIGS. 4-7. Such a notch may be effective to add axial strength to the reinforced wood product 100 and help it withstand horizontal shearing.

Embodiments of reinforced wood products 100 utilizing reinforcement components 104 with buckling resistance notches 106 (FIGS. 4-7) will now be described in detail. A person of ordinary skill in the art will appreciate that the embodiments shown in FIGS. 4-7 share many of the same features and structure with the embodiments described in FIGS. 1-3. Accordingly some of the details of the shared features and components will not be described in detail with respect to each embodiment to avoid unnecessary repetition.

Referring specifically to FIGS. 4 and 5, reinforcement components 104 according to the disclosure may include one or more metal plates attached to at least one reinforced surface of the wood component 102. In the embodiment shown in FIG. 4, reinforcement components 104 according to the disclosure may include a first metal plate 402 and a second metal plate 404. In the embodiment shown in FIG. 5, the reinforcement components 104 may additionally include a third metal plate 406 and a fourth metal plate 408. The reinforced surface for the first metal plate 402 may be the first lateral surface 112, the reinforced surface for the second metal plate 404 may be the second lateral surface 114, the reinforced surface for the third metal plate 406 may be the first lateral surface 112, and the reinforced surface for the fourth metal plate 408 may be the second lateral surface 114. In other embodiments, different configurations and numbers of metal plates may be used. In addition, the reinforced surface(s) may be different surface(s) than those explicitly shown.

FIG. 6 is a side view of a portion 600 of the reinforcement wood product 100 from FIG. 5. Referring to FIG. 6, in some embodiments, each metal plate (e.g., the third metal plate 406 is shown as an example) includes a first attachment section 412 and a second attachment section 414. The first attachment section 412 has a first inner surface 416 and a first outer surface 418. The second attachment section 414 has a second inner surface 420 and a second outer surface 422. The first attachment section 412 and the second attachment section 414 may be substantially the same size and shape or they can be different sizes and shapes. The buckling resistance notch 106 is located between the first attachment section 412 and the second attachment second 414. In some embodiments, the first attachment section 412 and the second attachment section 414 are located in the same plane. The buckling resistance notch 106 may extend into the wood component 102 in a direction that is substantially perpendicular to that plane.

In some embodiments, the buckling resistance notch 106 may extend into the wood component 102 to define a notch angle 424, thereby having a substantially V-shape. The notch angle 424 may be measured with respect to a secondary vertical axis 426. The secondary vertical axis 426 is shown as being substantially perpendicular to the first attachment section 412 and the second attachment section 414. In some embodiments, the notch angle 424 may measure anywhere between about 5 degrees and about 45 degrees with respect to the secondary vertical axis 426.

The buckling resistance notch 106 may be machined into the wood component prior to mounting of the one or more reinforcement components 104. Alternatively, the reinforcement components 104 may be applied to the wood component 102 with enough force to drive the buckling resistance notch 106 into the wood component 102. A person of ordinary skill in the art will appreciate that numerous methods exist for cutting buckling resistance notches 106 according to the disclosure and for machining reinforcement components 104 having buckling resistance notches 106.

Referring back to FIGS. 4 and 5, one or more fixation mechanisms may be used to attach the metal plates to the wood component 102. In some embodiments, fixation mechanisms according to the disclosure may include teeth, glue, screws, nails, or any other suitable means for attaching wood to metal that is known to a person of ordinary skill in the art. In the embodiments shown in FIG. 4-6, the one or more fixation mechanisms include one or more teeth 142 extending from the metal plates. The teeth 142 are configured to extend into the wood component 102 in an orientation that is substantially perpendicular to the reinforced surface. In some embodiments, the teeth 142 may extend into the wood component 102 substantially the same distance D3 as the buckling resistance notch 106 extends into the wood component 102. In other embodiments, the teeth 142 may extend deeper or shallower than the buckling resistance notch 106. Teeth 142 according to embodiments of the disclosure may be manufactured using any process known to a person of ordinary skill in the art.

FIG. 7 is a side view of a portion 600 of the reinforced wood product 100 from FIG. 5. In FIG. 7, a more detailed view of the reinforced surface is shown. In the embodiment in FIG. 7, the reinforced surface is the first lateral surface 112, which is parallel to the surface of the page. The first metal plate 402 is shown extending over about 75% of the height H of the wood component 102. In some embodiments, the first metal plate 402 (and other metal plates that are part of the reinforcement component 104) may extend over about 75% of the height H of the wood component 102 to about 100% of the height H of the wood component 102. The first attachment section 412 and the second attachment section 414 of the first metal plate 402 may have the same dimensions or different dimensions. In some embodiments, the dimensions of the first metal plate 402 (and other metal plates) may vary according to the dimensions of the wood component 102. In some embodiments, reinforcement components 104 according to the disclosure are attached to extend over less than about 35% of the length L of the wood component 102. This percentage may vary based on the number and size of the plates used. In some embodiments, reinforced wood products 100 according to the disclosure include one or more reinforcement components 104, which cover between about 15% and about 20% of the total surface area of the wood component 102.

Referring to FIGS. 4-7, reinforcement components 104 according to the disclosure may be arranged in various positions along the length L of the wood component 102. Different numbers and arrangements of metal plates may also be used with reinforcement components 104 according to the disclosure. In some embodiments, one or more metal plates may be arranged so that the reinforcement component 104 is substantially symmetric about the primary vertical axis 134. In other embodiments, reinforcement components 104 according to the disclosure do not exhibit such symmetry.

Words in the above disclosure using the singular or plural number may also include the plural or singular number, respectively. For example, use of the term “reinforced surface” could also apply to “reinforced surfaces” and the term “plate” could also apply to “plates.” Additionally, the words “herein,” “above,” “below” and words of similar import, when used in this application, shall refer to this application as a whole and not to any particular portions of this application. When the word “or” is used in reference to a list of two or more items, that word covers all of the following interpretations of the word: any of the items in the list, all of the items in the list, and any combination of the items in the list.

From the foregoing, it will be appreciated that the specific embodiments of the disclosure have been described herein for purposes of illustration, but that various modifications may be made without deviating from the disclosure. For example, although the disclosure describes the reinforcement components 104 as being constructed from metal plates, a person of ordinary skill in the art will appreciate that in some cases, a different material may be used in place of metal.

Aspects of the disclosure described in the context of particular embodiments may be combined or eliminated in other embodiments. For example, the features described with respect to embodiments having a buckling resistance notch 106 may be combined with features described with respect to embodiments not having a buckling resistance notch 106.

Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### Example 1

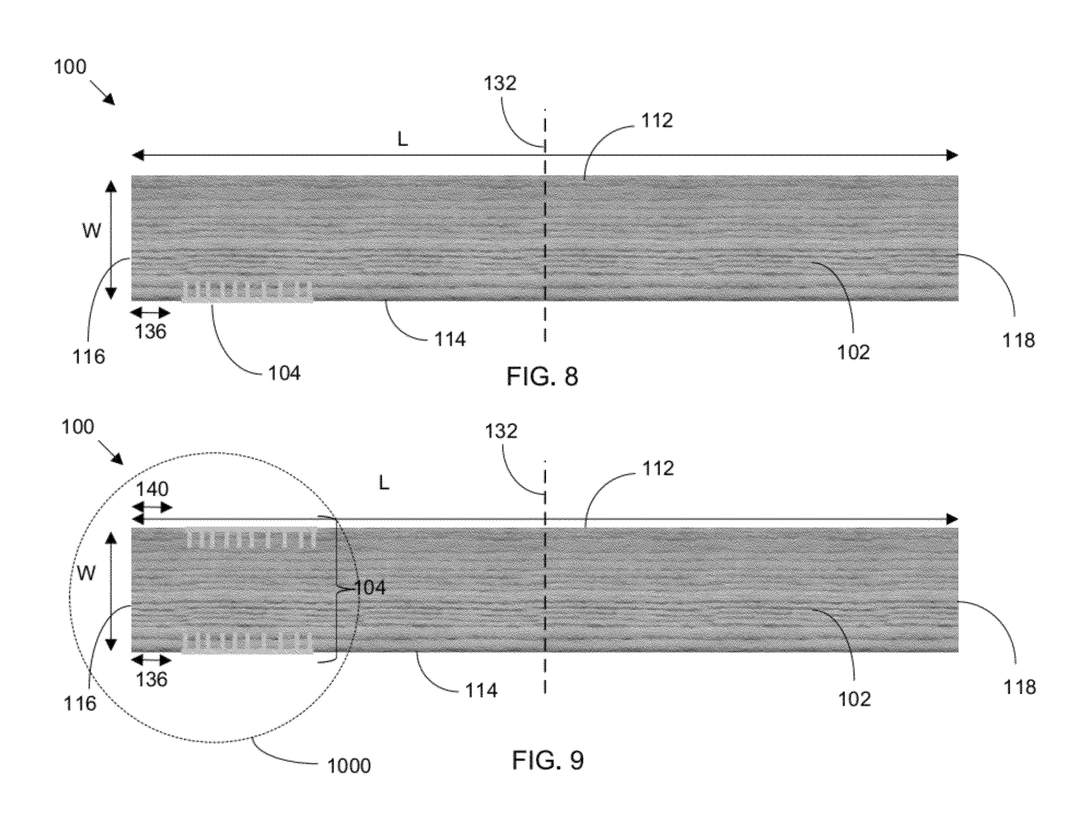

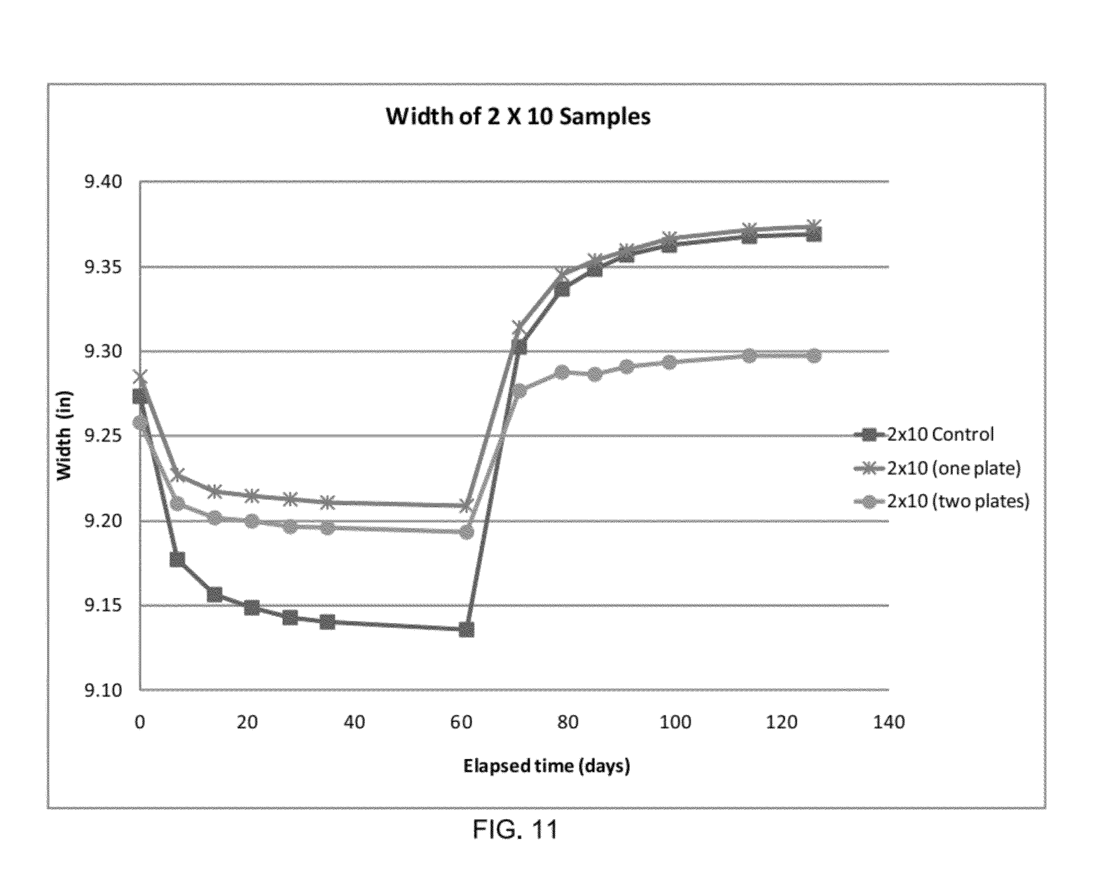

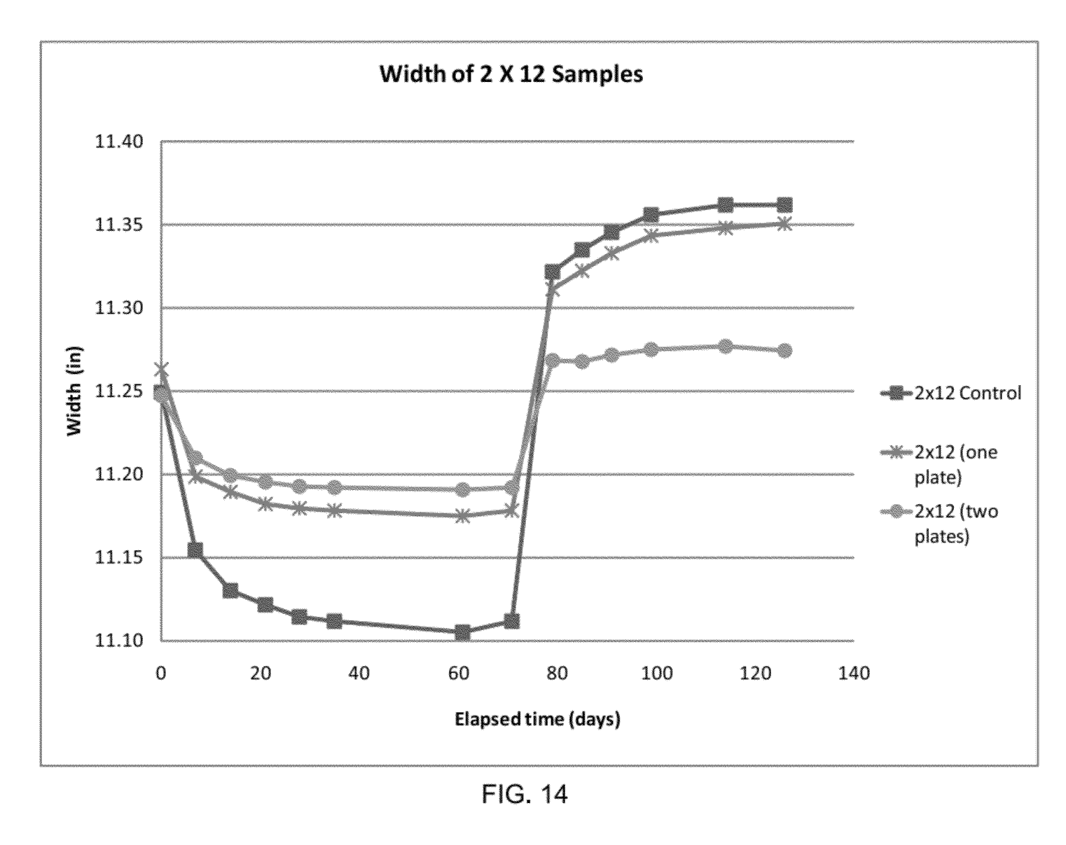

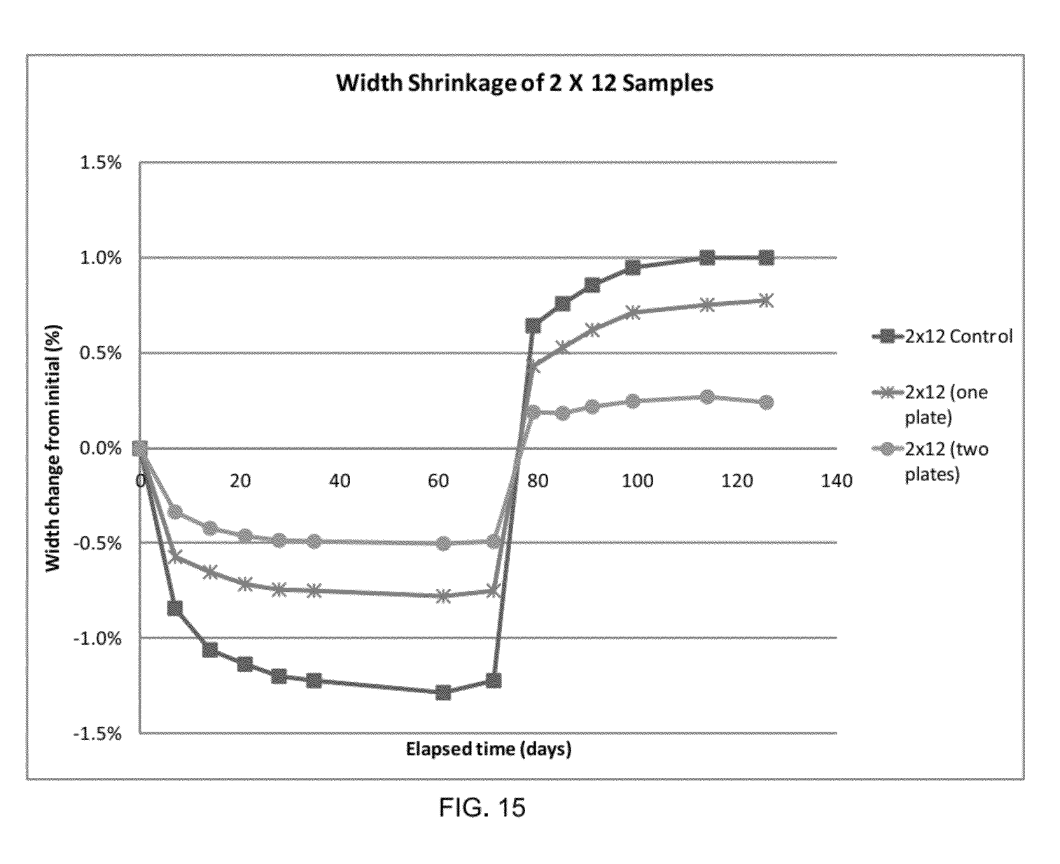

In order to evaluate the performance of reinforced wood products and reinforcement components according to embodiments of the disclosure, a number of laboratory tests were performed. Tests were performed on both 2×10 and 2×12 samples of lumber used in floor joist applications. FIGS. 8-10 illustrate schematics of the test samples used in Example 1 and Example 2. FIGS. 11-13 present the results for Example 1. FIGS. 14 and 15 present the results for Example 2.

In the first example, twelve 2×10 samples of South Yellow Pine lumber were provided and reinforcement components according to embodiments of the disclosure were mounted on the samples in various configurations. Each sample was cut to the following approximate dimensions: a length L of about 8 feet, a width W of about 1.5 inches, and a height of about 9.25 inches. Referring to FIGS. 8 and 9, reinforcement components 104 without buckling resistance notches 106 were used in all cases. For all of the samples, the reinforcement components 104 were mounted on the first end 116 of the wood component only. In some cases, the reinforcement components 104 included a single flat metal plate mounted on only one lateral side of the sample (see FIG. 8). In other cases, two flat metal plates were mounted in an opposed manner on two lateral sides of the sample (see FIG. 9).

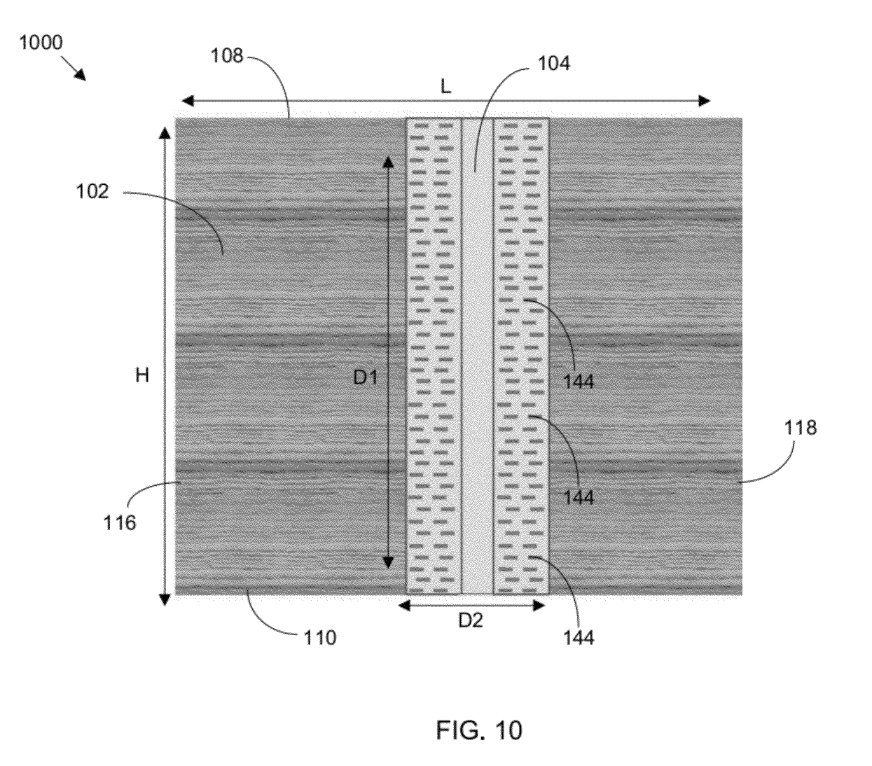

FIG. 10 shows an enlarged portion 1000 of the reinforced wood product 100 from FIG. 9. In the first example, the reinforcement components all had a first dimension D1 that extended the entire height of the wood component 102. Reinforcement components having varied second dimensions D2 were used for different samples. The samples were each fitted with reinforcement components 104 having a second dimension D2 measuring 1.50 inches, 2.25 inches, or 3.00 inches.

After mounting of the reinforcement components 104, each sample was cut in half along the horizontal axis 132. Accordingly, cutting effectively created 24 samples, each having an approximate length of L/2 or 4 feet. One half of the sample was used to represent a reinforced wood product 100 according to embodiments of the disclosure. The other half of the sample was used as a control. The samples were cut at ambient temperature and had initial moisture content ranging from about 12% to about 15%.

After cutting, the samples were exposed to various conditions typical of those experienced by wood products used in structural framing applications. The samples were observed for a total of 126 days and measurements of the change in width, moisture content, and shrinkage of the samples were recorded on a weekly basis. For the first 60 days, the samples were placed in a first room having a temperature of about 22° C. (Celsius) at about 20% humidity. For the remainder of the time, the samples were placed in a second room having a temperature of about 22° C. (Celsius) and exhibited approximately 90% humidity in order to increase the moisture content of the wood samples to standard test conditions.

After the elapsed time, the samples were removed from the second room and subjected to shear testing. This procedure involves a three point bending test whereby the primary anticipated mode of failure is in horizontal shear as the dimensional stability reinforcing system may influence the horizontal shear performance attribute of the wood member in service conditions.

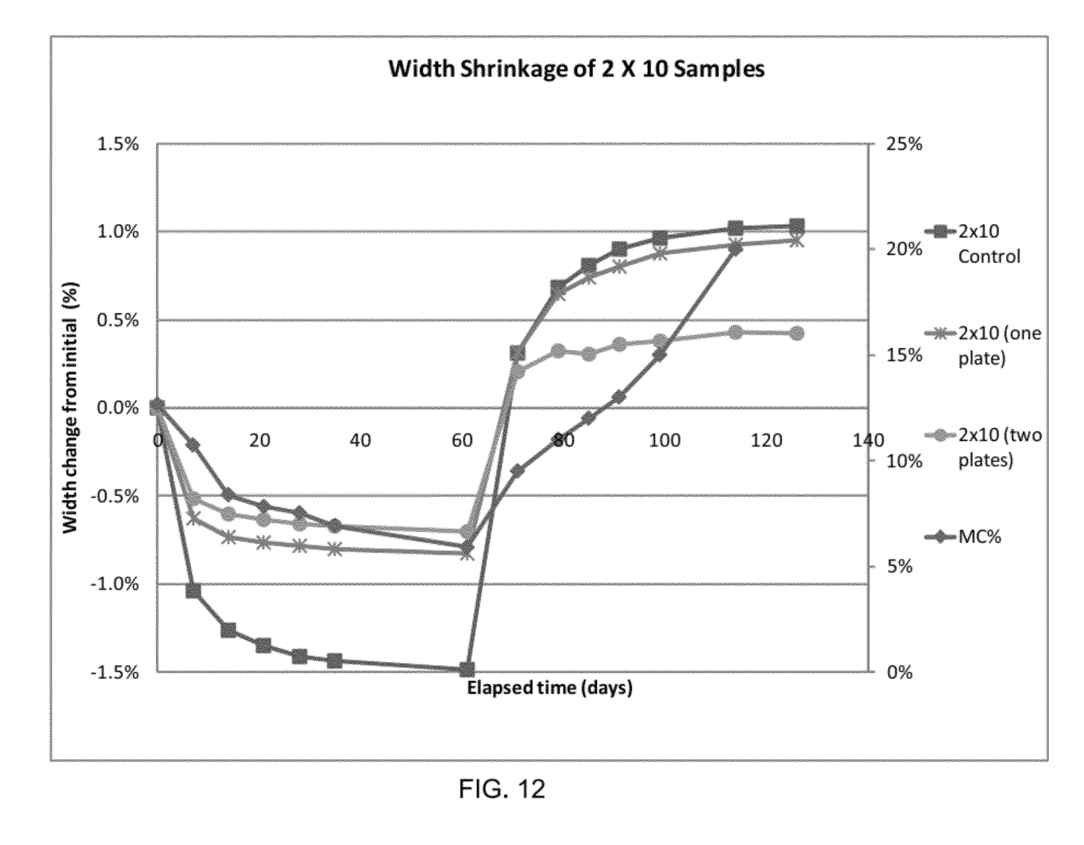

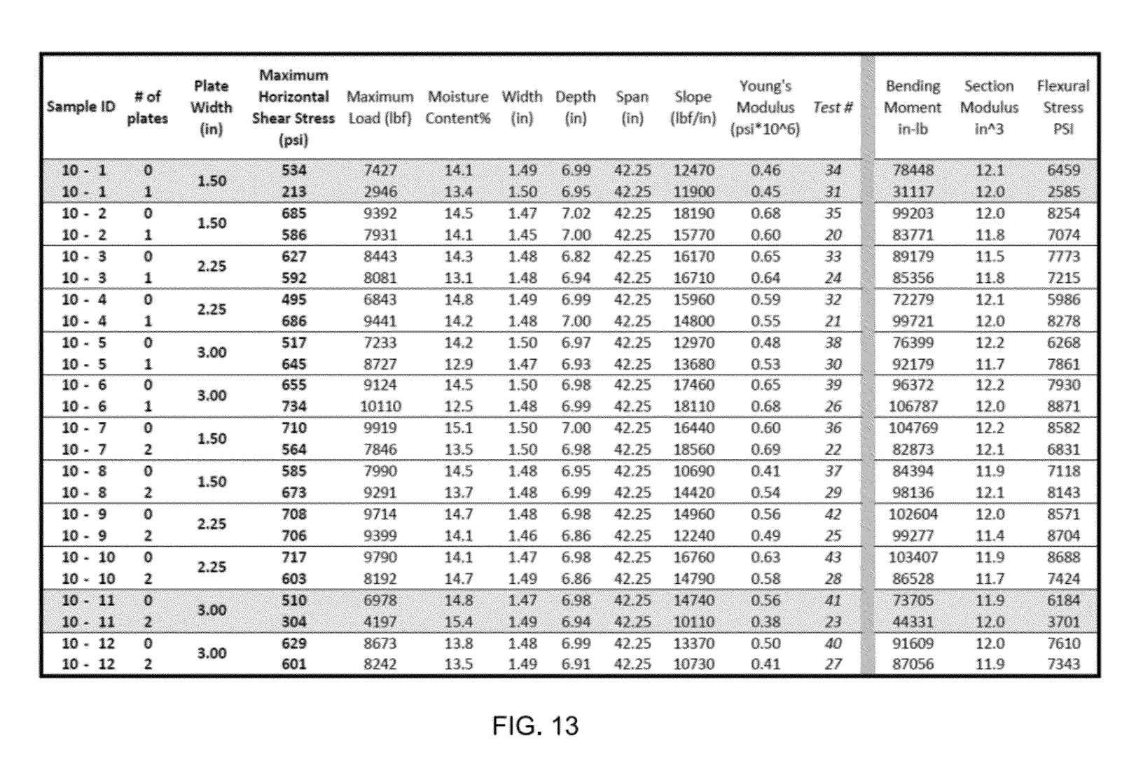

FIGS. 11-13 present the results of the experiments. FIG. 11 is a plot of width (inches) versus elapsed time (days). FIG. 12 is a plot of percentage of width change from initial width and moisture content (%) versus elapsed time (days). FIG. 13 is a chart presenting data from the horizontal shear test. A person of ordinary skill in the art will observe that the samples fitted with reinforcement components according to embodiments of the disclosure exhibited less width shrinkage than the control samples. In addition, in many cases the samples fitted with reinforcement components according to the disclosure (the samples having at least one plate in the chart in FIG. 13) were able to withstand a greater amount of maximum horizontal shear stress when compared with the control samples (the samples having no plates in the chart in FIG. 13).

### Example 2

In the second example, twelve 2×12 samples of South Yellow Pine lumber were provided and reinforcement components according to embodiments of the disclosure were mounted on the samples in various configurations. Each sample was cut to the following approximate dimensions: a length L of about 8 feet, a width W of about 1.5 inches, and a height of about 11.25 inches. Referring to FIGS. 8 and 9, reinforcement components 104 without buckling resistance notches 106 were used in all cases. For all of the samples, the reinforcement components 104 were mounted on the first end 116 of the wood component only. In some cases, the reinforcement components 104 included a single flat metal plate mounted on only one lateral side of the sample (see FIG. 8). In other cases, two flat metal plates were mounted in an opposed manner on two lateral sides of the sample (see FIG. 9).

FIG. 10 shows an enlarged portion 1000 of the reinforced wood product 100 from FIG. 9. In the first example, the reinforcement components all had a first dimension D1 that extended the entire height of the wood component 102. Reinforcement components having varied second dimensions D2 were used for different samples. The samples were each fitted with reinforcement components having a second dimension D2 measuring 1.50 inches, 2.25 inches, or 3.00 inches.

After mounting of the reinforcement components 104, each sample was cut in half along the horizontal axis 132. Accordingly, cutting effectively created 24 samples, each having an approximate length of L/2 or 4 feet. One half of the sample was used to represent a reinforced wood product 100 according to embodiments of the disclosure. The other half of the sample was used as a control. The samples were cut at ambient temperature and had initial moisture content ranging from about 12% to about 15%.

After cutting, the samples were exposed to various conditions typical of those experienced by wood products used in structural framing applications. The samples were observed for a total of 126 days and measurements of the change in width, moisture content, and shrinkage of the samples were recorded on a weekly basis. For the first 60 days, the samples were placed in a first room having a temperature of about 22° C. (Celsius) at about 20% humidity. For the remainder of the time, the samples were placed in a second room having a temperature of about 22° C. (Celsius) and exhibited approximately 90% humidity.

FIGS. 14 and 15 present the results of the experiments. FIG. 14 is a plot of width (inches) versus elapsed time (days). FIG. 15 is a plot of percentage of width change from initial width and moisture content (%) versus elapsed time (days). A person of ordinary skill in the art will observe that the samples fitted with reinforcement components according to embodiments of the disclosure exhibited less width shrinkage than the control samples.

In summary, the experiments demonstrated the reinforced wood products according to the disclosure are expected to perform better than non-reinforced wood products having similar properties. Reinforcement components according to the disclosure may be effective in reducing negative effects associated with shrinking and swelling in wood products used for structural framing. In addition, installing reinforcement components on wood products according to the disclosure may help the wood product withstand horizontal shearing forces.

I/We claim:

1. A reinforced wood product comprising:
a wood component having a length, a width, a height, a top surface, a bottom surface, a first lateral surface, a second lateral surface, and two ends;
a reinforcement component comprising:
one or more metal plates attached to at least one reinforced surface of the wood component; and
one or more fixation mechanisms configured to attach the one or more metal plates to the wood component;
wherein the reinforcement component extends over less than about 35% of the length of the wood component; and
wherein the at least one reinforced surface of the wood component is selected from the group consisting of at least one of: the first lateral surface of the wood component and the second lateral surface of wood component.

2. The reinforced wood product of claim 1 wherein the reinforcement component extends over about 75% of the height of the wood product.

3. The reinforced wood product of claim 1 wherein the at least one reinforced surface has a reinforced surface area and the reinforcement component covers about 15% to about 20% of the reinforced surface area.

4. The reinforced wood product of claim 1, further comprising:
one or more buckling resistance notches located on the one or more metal plates, the one or more buckling resistance notches extending into the width of wood component.

5. The reinforced wood product of claim 1 wherein each of the one or more metal plates comprises:
a first attachment section mounted on the at least one reinforced surface so that the first attachment section is substantially parallel to the at least one reinforced surface;
a second attachment section mounted on the at least one reinforced surface so that the second attachment section is substantially parallel to the at least one reinforced surface; and
a buckling resistance notch located between the first attachment section and the second attachment section.

6. The reinforced wood product of claim 5 wherein the buckling resistance notch extends into the at least one reinforced surface defining a notch angle, the notch angle being between about 5 degrees and about 45 degrees with respect to a horizontal axis, the horizontal axis being substantially perpendicular to the at least one reinforced surface.

7. The reinforced wood product of claim 1 wherein the one or more fixation mechanisms are teeth, glue, screws, or nails.

8. The reinforced wood product of claim 1 wherein the wood component is solid sawn lumber.

9. The reinforced wood product of claim 1 wherein the one or more fixation mechanisms each comprise one or more teeth extending from each of the one or more metal plates into the wood component in a configuration that is substantially perpendicular to the at least one reinforced surface.

10. A reinforced wood product comprising:
a wood component having a top surface, a bottom surface, a first lateral surface, a second lateral surface, and two ends; and
a reinforcement component comprising:
a first metal plate attached to the first lateral surface of the wood component;
a second metal plate attached to the second lateral surface of the wood component;
one or more first fixation mechanisms configured to attach the first metal plate to the wood component; and
one or more second fixation mechanisms configured to attach the second metal plate to the wood component;
wherein the first metal plate extends over less than about 30% of the first lateral surface's total surface area; and
wherein the second metal plate extends over less than 30% of the second lateral surface's total surface area.

11. The reinforced wood product of claim 10 where the first metal plate and the second metal plate each cover less than about 35% of the length of the wood component.

12. The reinforced wood product of claim 10 wherein the reinforcement component further comprises:
a first buckling resistance notch located on the first metal plate and extending into the width of the wood component towards the second lateral surface in a direction substantially perpendicular to the first metal plate; and
a second buckling resistance notch located on the second metal plate and extending into the width of the wood component towards the first lateral surface in a direction substantially perpendicular to the second metal plate.

13. The reinforced wood product of claim 12 wherein the first buckling resistance notch and the second buckling resistance notch each have a substantially V-shape.

14. The reinforced wood product of claim 10 wherein the first metal plate and the second metal plate are mounted on the wood component so that the reinforcement component is substantially symmetrical about a vertical axis, the vertical axis being substantially parallel to the first lateral surface and the second lateral surface.

15. The reinforced wood product of claim 12 wherein the reinforcement component further comprises:
a third metal plate attached to the first lateral surface of the wood component;
a fourth metal plate attached to the second lateral surface of the wood component;
one or more third fixation mechanisms configured to attach the third metal plate to the wood component; and
one or more fourth fixation mechanisms configured to attach the fourth metal plate to the wood component.

16. The reinforced wood product of claim 15 wherein the reinforcement component further comprises:
a third buckling resistance notch located on the third metal plate and extending into the width of the wood component towards the second lateral surface in a direction substantially perpendicular to the third metal plate; and
a fourth buckling resistance notch located on the fourth metal plate and extending into the width of the wood component towards the first lateral surface in a direction substantially perpendicular to the fourth metal plate.

17. A reinforcement component for use with a wood product comprising:
one or more metal plates, each of the one or more metal plates comprising:
a first attachment section having a first inner surface and a first outer surface;
a second attachment section having a second inner surface and a second outer surface; and
a buckling resistance notch located between the first attachment section and the second attachment second;
one or more first fixation mechanisms, each of the one or more first fixation mechanisms comprising one or more first teeth extending from the first inner surface in a configuration substantially perpendicular to the first attachment section; and
one or more second fixation mechanisms, each of the one or more second fixation mechanisms comprising one or more second teeth extending from the second inner surface in a configuration substantially perpendicular to the second attachment section.

18. The reinforcement component of claim 17 wherein the buckling resistance notch has a substantially V-shape.

19. The reinforcement component of claim 17 wherein the first attachment section and the second attachment section are arranged in a single plane.

20. The reinforcement component of claim 19 wherein the buckling resistance notch extends in a direction substantially perpendicular to the single plane to define a notch angle, the notch angle being between about 5 degrees and about 45 degrees with respect to a vertical axis, the vertical axis being substantially perpendicular to the single plane.
